(19) United States
(12) Patent Application Publication
(10) Pub. No.: US 2018/0275539 A1
(43) Pub. Date: Sep. 27, 2018

(54) TONER AND MANUFACTURING METHOD THEREOF, TONER CARTRIDGE, DEVELOPMENT DEVICE, AND IMAGE FORMATION APPARATUS

(71) Applicant: Oki Data Corporation, Tokyo (JP)

(72) Inventor: Naoki MASUI, Tokyo (JP)

(73) Assignee: Oki Data Corporation, Tokyo (JP)

(21) Appl. No.: 15/923,107

(22) Filed: Mar. 16, 2018

(30) Foreign Application Priority Data
Mar. 27, 2017 (JP) 2017-61147

(51) Int. Cl. G03G 9/08; G03G 9/087; G03G 15/08; G03G 15/01; G03G 21/00

(52) U.S. Cl. CPC G03G 9/08; G03G 9/08755; G03G 9/0827; G03G 9/0804; G03G 15/0865; G03G 15/01; G03G 2215/2048; G03G 2215/0607; G03G 2221/0005; G03G 2215/0409; G03G 2215/1614; G03G 2215/021; G03G 21/0017

(57) ABSTRACT

A toner according to an embodiment includes: a toner base particle that includes a binder that contains polyester resin; and an external additive externally added to the toner base particle. A difference obtained by subtracting a specific surface area of the toner after removal of the external additive from a specific surface area of the toner before removal of the external additive is 0.75 m²/g or more and less than 1.00 m²/g.

### CROSS REFERENCE TO RELATED APPLICATIONS

This application claims priority based on 35 USC 119 from prior Japanese Patent Application No. 2017-061147 filed on Mar. 27, 2017, entitled “TONER AND MANUFACTURING METHOD THEREOF, TONER CARTRIDGE, DEVELOPMENT DEVICE, AND IMAGE FORMATION APPARATUS”, the entire contents of which are incorporated herein by reference.

### BACKGROUND

The present disclosure relates to toner including an external additive and a manufacturing method thereof, as well as a toner cartridge, a development device, and image formation apparatus which use the toner.

The electrophotographic image formation apparatus has been widely used. This is because the electrophotographic image formation apparatus can make a clearer image in shorter time than an image formation apparatus of another type such as an ink-jet type.

The electrophotographic image formation apparatus performs development processing using toner to form an image. This toner includes a binder, an external additive, and other components.

Since a structure of the toner affects a quality of the image, there have been different proposals for the structure of the toner. Specifically, in order to reduce image quality deterioration due to desorption of the external additive, a relation between a specific surface area of unused toner and a specific surface area of used toner is defined (see Patent literature 1, for example). This toner is manufactured using an emulsion aggregation method, and includes a binder containing styrene acrylic copolymer resin.

Patent literature 1: Japanese Patent Application Publication No. 2011-145450.

### SUMMARY

There have been specific considerations on the structure of the toner in order to form a high-quality image; however, there is still room for improvement.

An object of an embodiment of this disclosure is to provide toner capable of forming a high-quality image and a manufacturing method thereof, as well as a toner cartridge, a development device, and image formation apparatus.

A first aspect of the disclosure is a toner that includes: a toner base particle that includes a binder that contains polyester resin; and an external additive externally added to the toner base particle. A difference obtained by subtracting a specific surface area after removal of the external additive from a specific surface area before removal of the external additive is 0.75 m²/g or more and less than 1.00 m²/g.

A second aspect of this disclosure is a method of manufacturing a toner, wherein the method includes: forming a toner base particle that includes a binder that contains polyester resin using a dissolution-suspension method; and externally adding an external additive onto the toner base particle to manufacture toner that includes the binder and the external additive. A difference obtained by subtracting a specific surface area of the toner after removal of the external additive from a specific surface area of the toner before removal of the external additive is 0.75 m²/g or more and less than 1.00 m²/g.

A third aspect of this disclosure is a toner cartridge that stores therein the toner according to the above described aspect.

A fourth aspect of this disclosure is a development device that includes: a toner carrier member on which the toner according to the above describe aspect is carried; and a latent image carrier member that carries a latent image to which the toner from the toner carrier member is to be adhered to form a toner image.

A fifth aspect of this disclosure is an image formation apparatus that a medium storage in which a medium is placed; the development device according to the above described aspect; a transfer device that transfers the toner image from the development device to the medium conveyed from the medium storage; and a fixation device that fuses the toner image transferred on the medium to the medium.

In this disclosure, “toner” may include a colorant or not. Toner including the colorant is what is called colored toner while toner including no colorant is what is called colorless (transparent color) toner. A type of the colored toner is, for example, yellow toner, magenta toner, cyan toner, black toner, white toner, and the like; however, it is not limited thereto. The colorless toner is also called a clear toner.

A “specific surface area” is a specific surface area measured using a BET method (nitrogen); that is, a BET specific surface area (a nitrogen adsorption specific surface area).

“Toner before removal of the external additive” is, in other words, toner in the finished state (or in the product state). Thus, needless to say, the toner before removal of the external additive includes that external additive.

“Toner after removal of the external additive” is toner that is the above finished toner on which removal processing of the external additive is provided and from which the external additive is purposely removed. Thus, unlike the above toner before removal of the external additive, the toner after removal of the external additive includes almost no external additives. Details of the removal processing of the external additive are described later.

According to the above aspect(s), since a difference obtained by subtracting a specific surface area of the toner after removal of the external additive from a specific surface area of the toner before removal of the external additive is within the above range, a high-quality image can be formed.

### BRIEF DESCRIPTION OF DRAWINGS

FIG. 1 is a plan view schematically illustrating a structure of toner according to an embodiment;

FIG. 2 is a plan view schematically illustrating a structure of toner according to a first comparative example to be compared to the toner structure shown in FIG. 1;

FIG. 3 is a plan view schematically illustrating a structure of toner according to a second comparative example to be compared to the toner structure shown in FIG. 1;

FIG. 4 is a plan view schematically illustrating a structure of the toner (in a state after a removal processing of external additive is completed) according to the embodiment;

FIG. 5 is a plan view schematically illustrating a structure of the toner (in a state after a removal processing of external additive is completed) according to the first comparative example to be compared to the toner structure shown in FIG. 4;

FIG. 6 is a plan view schematically illustrating a structure of other toner (in a state after a removal processing of external additive is completed) according to the second comparative example to be compared to the toner structure shown in FIG. 4;

FIG. 7 is a magnified plan view illustrating a part of a surface of the toner illustrated in FIG. 1;

FIG. 8 is a magnified plan view illustrating a part of a surface of the toner illustrated in FIG. 4;

FIG. 9 is a magnified plan view illustrating a part of surfaces of the toner illustrated in FIGS. 2 3;

FIG. 10 is a magnified plan view illustrating a part of a surface of the toner illustrated in FIGS. 5 and 6;

FIG. 11 is a plan view illustrating a configuration of image formation apparatus according to one or more embodiments;

FIG. 12 is a magnified plan view illustrating a configuration of a development device illustrated in FIG. 11;

FIG. 13 is a plan view illustrating a configuration of a medium on which an image for density measurement is formed; and

FIG. 14 is a graph of a correlation between a specific surface area difference ΔS and fading levels.

FIG. 15 is a table of physical properties of toner of Examples 1 to 9.

### DETAILED DESCRIPTION

Descriptions are provided hereinbelow for embodiments based on the drawings. In the respective drawings referenced herein, the same constituents are designated by the same reference numerals and duplicate explanation concerning the same constituents is omitted. All of the drawings are provided to illustrate the respective examples only.

Descriptions are given in the following order.

1. Toner
1-1. Structure
1-2. Physical Properties
1-3. Manufacturing Method
1-4. Operation and Effect

2. Image Formation Apparatus (Toner Cartridge and Development Device)
2-1. Overall Configuration
2-2. Details of Configuration of Development device
2-3. Performance
2-4. Operation and Effect

3. Modification

### <1. Toner>

First, toner of one embodiment is described.

The toner described herein is used in electrophotographic image formation apparatus, for example. More specifically, the toner is used for development processing performed by a development device mounted in the image formation apparatus.

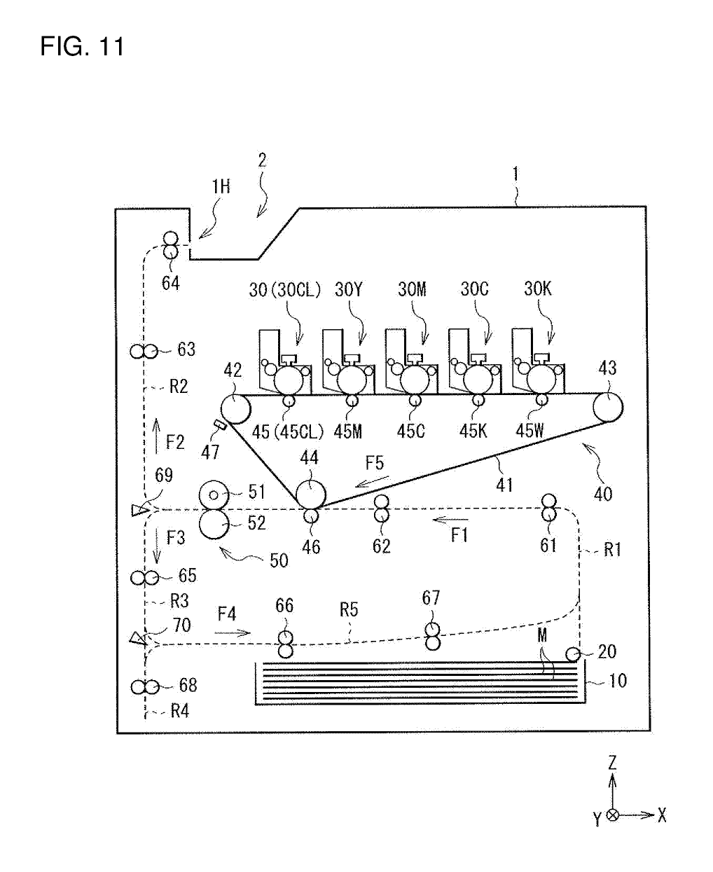

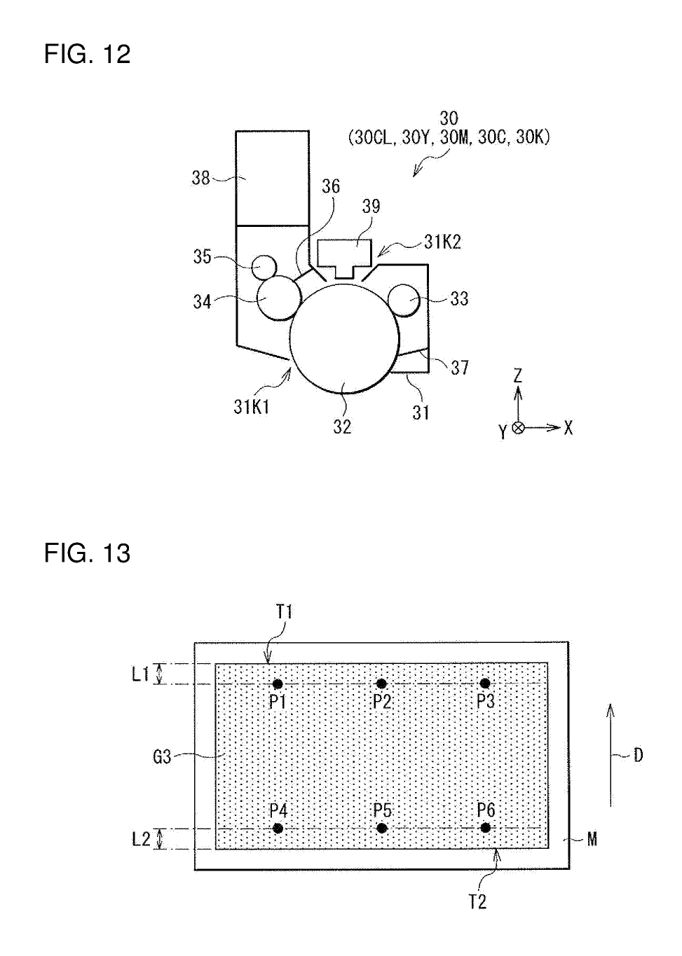

In this image formation apparatus, the toner fuses onto a surface of a medium for image formation (hereinafter simply referred to as a “medium”), thereby forming an image on the surface of that medium. Details of the image formation apparatus and the medium are described later respectively (see FIGS. 11 and 12).

This toner is, for example, negatively charged toner for a one-component development method, which has a negative charge polarity. The one-component development method is a method for applying an appropriate amount of charge to the toner itself without using a carrier (a magnetic particle) for applying charge to the toner. On the other hand, a two-component development method is a method for applying an appropriate amount of charge to the toner using the above carrier and friction between that carrier and the toner.

### <1-1. Structure>

First, a structure of the toner is described.

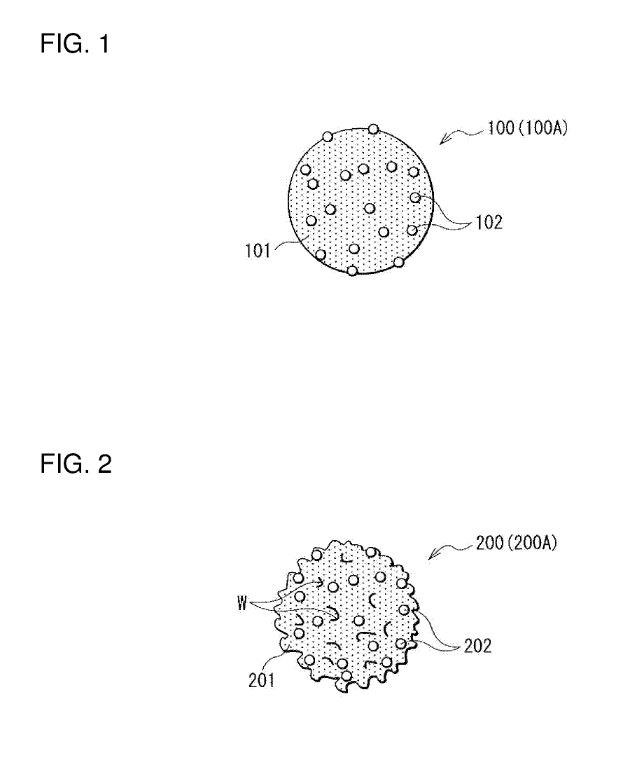

FIG. 1 is a plane view that schematically illustrates a structure of toner 100 according to an embodiment. Note that FIG. 1 illustrates a product state of the toner 100, which may be referred in this disclosure as to unprocessed toner 100A. Details of the unprocessed toner 100A is described later.

This toner 100 includes a binder and an external additive. Note that the toner 100 may also include, for example, one type or two or more types of other materials in addition to the above binder and the external additive.

Specifically, for example, as illustrated in FIG. 1, the toner 100 includes a toner base particle 101 including the binder and an external additive 102 fused on a surface of that toner base particle 101. In FIG. 1, the toner base particle 101 is shaded for making the toner base particle 101 and the external additive 102 distinguishable.

In this toner 100, since the toner base particle 101 is formed using a later-described dissolution-suspension method, a three-dimensional shape of that toner base particle 101 is substantially spherical. Thus, a three-dimensional shape of the toner 100 including the toner base particle 101 and the external additive 102 is a shape that reflects the three-dimensional shape of the toner base particle 101, that is, substantially spherical.

Accordingly, the circularity of the toner 100 manufactured using the dissolution-suspension method is sufficiently larger than that of other toner manufactured using a method different from that dissolution-suspension method. In other words, the circularity of the toner 100 manufactured by the dissolution-suspension method is much closer to 1.

The circularity of the toner 100 is, for example, 0.950 or more; however, it is not limited thereto. In other words, the circularity of the toner 100 is a sufficiently large value, and more specifically, 0.950 or more of the circularity of the toner 100 substantially means that this toner 100 is manufactured by the dissolution-suspension method. The circularity described herein is the circularity of the unprocessed toner 100A.

### [Binder]

The binder mainly holds the external additive. However, in a case where the toner 100 also includes other materials such as a later-described colorant, the binder also serves to bind those other materials such as the colorant.

As described above, the toner 100 is manufactured using the dissolution-suspension method, and the binder described herein includes polyester resin. As described above, in a case where the toner 100 is manufactured using the dissolution-suspension method, the circularity of the toner 100 becomes sufficiently large. Thus, the toner 100 having the sufficiently large circularity and the binder including polyester resin is supposed to be manufactured by the dissolution-suspension method.

As described later, when the toner 100 is manufactured using the dissolution-suspension method, the toner base particle 101 including the binder is firstly formed using the dissolution-suspension method, and then the external additive 102 is externally added onto that toner base particle 101. As a result, the toner 100 including the binder and the external additive 102 is obtained.

The following advantages can be obtained in the case where the binder includes polyester resin. First, since polyester resin has great affinity for a medium such as paper, the toner 100 is easily fused on the medium such as paper. Second, since polyester resin has a relatively small molecular weight but high physical strength, the toner 100 has excellent durability. Third, even if the toner 100 essentially has a low charge characteristic, the toner 100 is easily fused on the medium.

A crystalline state of the polyester resin is not limited. Thus, the polyester resin may be crystalline polyester resin, non-crystalline polyester resin, or polyester resin including both a crystalline part and a non-crystalline part. Above all, the polyester resin is preferably the crystalline polyester resin because the toner 100 is fused on the medium more easily, and the durability of the toner 100 further improves.

This polyester resin is, for example, a reactant (a condensation polymer) from one type or two or more types of alcohol and one type or two or more types of carboxylic acid.

The type of the alcohol is not limited but is preferably alcohol having two or more valencies and a derivative thereof. The alcohol having two or more valencies is, for example, ethylene glycol, diethylene glycol, triethylene glycol, polyethylene glycol, propylene glycol, butanediol, pentanediol, hexanediol, cyclohexanedimethanol, xylene glycol, dipropylene glycol, polypropylene glycol, bisphenol-A, hydrogenated bisphenol-A, bisphenol-A ethylene oxide, bisphenol-A propylene oxide, sorbitol, glycerin, and the like.

The type of the carboxylic acid is not limited but is preferably carboxylic acid having two or more valencies and a derivative thereof. The carboxylic acid having two or more valencies is, for example, maleic acid, fumaric acid, phthalic acid, isophthalic acid, terephthalic acid, succinic acid, adipic acid, trimellitic acid, pyromellitic acid, cyclopentanedicarboxylic acid, succinic anhydride, trimellitic anhydride, maleic anhydride, dodecenyl succinic anhydride, and the like.

The binder may include one type or two or more types of other resin in addition to the above polyester resin. The other resin is thermoplastic resin and the like, for example. A type of the thermoplastic resin is, for example, vinyl resin, polyamide resin, polyurethane resin, and the like; however, it is not limited thereto.

### [External Additive]

Mainly, for example, the external additive 102 suppresses clumping of the toner 100 to improve flow properties of that toner 100. Hereinafter, the essential function of the above external additive 102 is referred to as an “external-addition function.”

As illustrated in FIG. 1, the external additive 102 has a form of multiple particles (powders), for example. A state of the external additive 102 in the multiple particles form distributed on the surface of the toner base particle 101 is not limited; however, the external additive 102 in the multiple particles form is preferably distributed as much as possible because it makes the external additive 102 exerts the external-addition function more easily.

Note that a part of the external additive 102 in the multiple particles form may go inside the toner base particle 101, for example. In this case, since a part of the external additive 102 goes inside the toner base particle 101, the rest of the external additive 102 may be exposed at the toner base particle 101. Otherwise, when all particles of the external additive 102 go inside the toner base particle 101, that external additive 102 may be buried inside the toner base particle 101.

This external additive includes one type or two or more types of inorganic materials, organic materials, and the like. The inorganic material is, for example, silica and the like. The organic material is, for example, melamine resin and the like.

### [Other Materials]

Other materials are, for example, the colorant, a release agent, a charge controller, a conductivity adjuster, reinforcement filler, an antioxidant, an anti-aging agent, a flow improver, a cleaning improver, and the like. One of or all of these other materials are, for example, included in the toner base particle 101.

### [Colorant]

The colorant mainly puts a color on the toner 100. As described above, this toner 100 may include the colorant or not.

The toner 100 including the colorant is what is called colored toner while the toner 100 including no colorant is what is called colorless (transparent color) toner. A type of the colored toner is, for example, yellow toner, magenta toner, cyan toner, black toner, and white toner; however, it is not limited thereto. The colorless toner is also called clear toner.

The colorant includes, for example, one type or two or more types of coloring materials corresponding to the color of the toner 100.

Specific examples of the coloring materials are described herein referring to the above five colors (yellow, magenta, cyan, black, and white) as an example of the color of the toner 100, for example.

The coloring material for yellow is, for example, a yellow pigment and the like. A type of the yellow pigment is, for example, Pigment Yellow 74 and the like; however, it is not limited thereto.

The coloring material for magenta is, for example a magenta pigment and the like. A type of the magenta pigment is, for example, Pigment Red 122, quinacridone, and the like; however, it is not limited thereto.

The coloring material for cyan is, for example, a cyan pigment and the like. A type of the cyan pigment is, for example, Copper Pigment Blue 15:3, phthalocyanine, and the like; however, it is not limited thereto.

The coloring material for black is, for example, a black pigment and the like. A type of the black pigment is, for example, carbon black and the like; however, it is not limited thereto.

The coloring material for white is, for example, a cyan pigment and the like. A type of the white pigment is, for example, titanium oxide, and the like; however, it is not limited thereto.

The colorant may include two or more types of colors of coloring materials in order to adjust the color of the toner 100 to a desired color.

Mainly, the release agent improves fusing properties, offset resistance, and the like of the toner 100. This release agent includes, for example, one type or two or more types of wax. A type of the wax is, for example, aliphatic hydrocarbon wax, oxide of aliphatic hydrocarbon wax, aliphatic ester wax, a product of deoxidation of aliphatic ester wax, a block copolymer of two or more types of the above, and the like; however, it is not limited thereto.

The aliphatic hydrocarbon wax is, for example, low-molecular-weight polyethylene, low-molecular-weight polypropylene, an olefin copolymer, micro crystallin wax, paraffin wax, Fischer-Tropsch wax, and the like. The oxide of aliphatic hydrocarbon wax is, for example, oxidized polyethylene wax and the like. The aliphatic ester wax is, for example, carnauba wax, montanic acid ester wax, and the like. The product of deoxidation of aliphatic ester wax is wax in which a part of or all of that aliphatic ester wax is deoxidized and that is, for example, deoxidized carnauba wax and the like.

Above all, the aliphatic hydrocarbon wax, the aliphatic ester wax, and the like are preferred because a later-described dispersion phase can be easily prepared in a step of manufacturing the toner 100 using the dissolution-suspension method, and because the release agent can be contained into the toner base particle 101 more easily.

The charge controller mainly controls frictional charge properties of the toner 100, for example. The charge controller used for negative charge toner is one type or two or more types of complexes such as an azo complex, a salicylic acid complex, a calixarene complex, and the like.

### <1-2. Physical Properties>

Next, physical properties of the toner 100 are described.

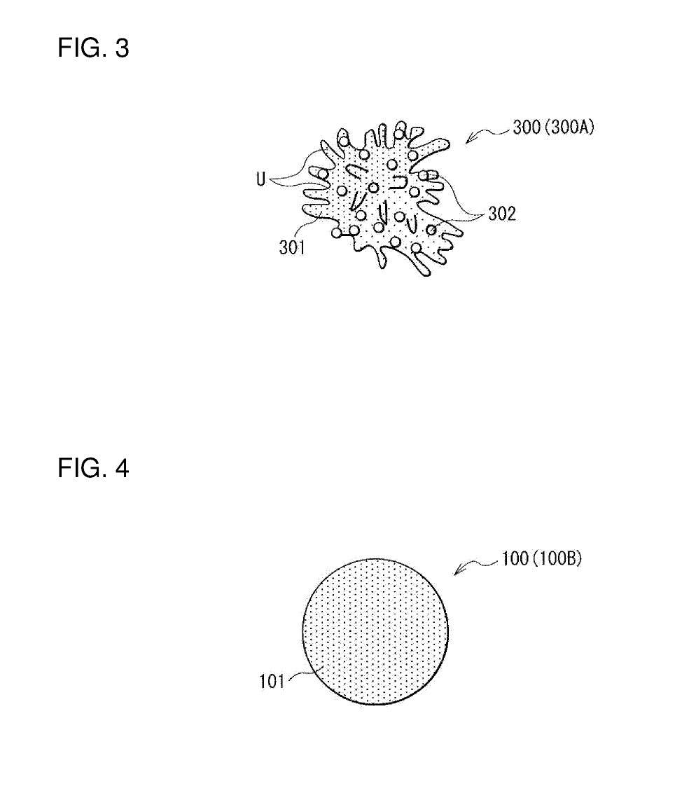

FIG. 2 is a plan view that schematically illustrates a structure of toner 200 of a first comparative example compared to the toner 100 of FIG. 1. FIG. 3 is a plan view that schematically illustrates a structure of toner 300 of a second comparative example compared to the toner 100 of FIG. 1. The toner 100, 200, and 300 illustrated in FIGS. 1 to 3 are product states of the toner 100, 200, and 300 which may be referred as to unprocessed toner 100A, 200A, and 300A respectively. Details of the unprocessed toner 100A, 200A, and 300A are described later.

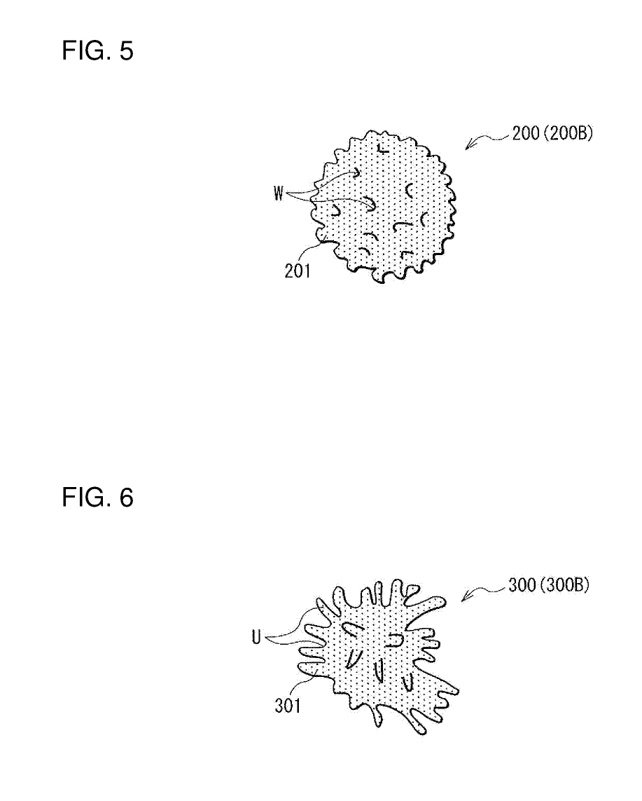

FIG. 4 is a plan view that schematically illustrates a structure of the toner 100 of FIG. 1 in a state after a removal processing of external additive is completed. FIG. 5 is a plan view that schematically illustrates a structure of the toner 200 of FIG. 2 in a state after a removal processing of external additive is completed. FIG. 6 is a plan view that schematically illustrates a structure of the toner 300 of FIG. 3 in a state after a removal processing of external additive is completed. The toner 100, 200, and 300 illustrated in FIGS. 4 to 6 are toner in a state after a removal processing of external additive is completed, which may be referred as to removal-processed toner 1008, 200B, and 300B in this disclosure. Details of the removal-processed toner 1008, 200B, and 300B are described later.

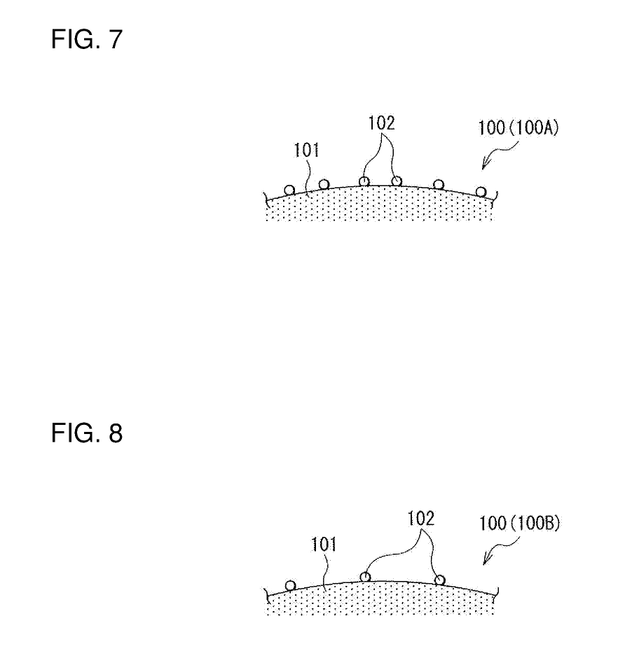

In order to describe an advantage of the toner 100, FIGS. 7 and 8 magnify a part of the surface of the toner 100 illustrated in FIGS. 1 and 4. Note that FIG. 7 illustrates the unprocessed toner 100A while FIG. 8 illustrates the removal-processed toner 1008.

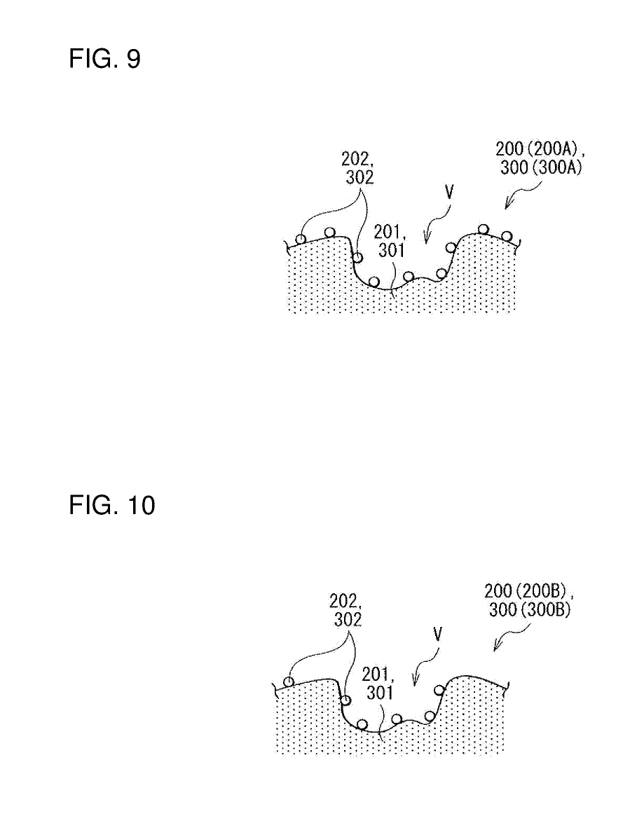

In order to describe problems of the toner 200 and 300, FIGS. 9 and 10 magnify a part of surfaces of the toner 200 and 300 illustrated in FIGS. 2, 3, 5 and 6. Note that FIG. 9 illustrates the unprocessed toner 200A and 300A while FIG. 10 illustrates the removal-processed toner 200B and 300B.

### [Specific Surface Area Difference ΔS]

In order to form a high-quality image using the toner 100, the physical properties (specific surface area) of that toner 100 is made appropriate.

Specifically, focusing on a specific surface area S1 of the toner 100 before removal of the external additive 102 and a specific surface area S2 of the toner 100 after removal of the external additive 102, a difference (a specific surface area difference) ΔS obtained by subtracting the specific surface area S2 from the specific surface area S1 (=S1−S2) is 0.75 m²/g or more and less than 1.00 m²/g. Hereinafter, a range of the above specific surface area difference ΔS (0.75 m²/g or more and less than 1.00 m²/g) is referred to as an “appropriate range.”

Here, as described above, the “specific surface areas S1 and S2” are specific surface areas measured using a BET method (nitrogen); that is, a BET specific surface area (a nitrogen adsorption specific surface area).

In order to measure the specific surface areas S1 and S2, a micromeritics automatic surface area and porosimetry analyzer, TriStar 3000, manufactured by SHIMADZU CORPORATION is used, for example. In order to obtain the specific surface area difference ΔS, the specific surface areas S1 and S2 are measured, and then the specific surface area difference ΔS is calculated based on those measured specific surface areas S1 and S2.

As described above, the “toner 100 before removal of the external additive 102” is the toner 100 manufactured using the dissolution-suspension method, that is, the toner 100 in the finished state (or in the product state). Thus, needless to say, the toner 100 before removal of the external additive 102 includes that external additive 102 as illustrated in FIG. 1.

On the other hand, as described above, the “toner 100 after removal of the external additive 102” is the toner 100 that is the finished toner 100 on which removal processing of the external additive 102 is provided and from which the external additive 102 is purposely removed. Thus, as illustrated in FIG. 4, unlike the above toner 100 before removal of the external additive 102, the toner 100 after removal of the external additive 102 includes almost no external additive 102.

As described above, the toner 100 after removal of the external additive 102 (FIG. 4) can be obtained by providing the removal processing of the external additive 102 on the toner 100 before removal of the external additive 102 (FIG. 1). Details of the removal processing of the external additive 102 are described later.

Hereinafter, in order to distinguish between the toner 100 before removal of the external additive 102 and the toner 100 after removal of the external additive 102, the toner 100 before removal of the external additive 102 is referred to as “unprocessed toner 100A” while the toner 100 after removal of the external additive 102 is referred to as “removal-processed toner 100B.”

In other words, the “specific surface area S1 of the toner 100 before removal of the external additive 102” is a specific surface area that is measured according to the unprocessed toner 100A illustrated in FIG. 1. On the other hand, the “specific surface area S2 of the toner 100 after removal of the external additive 102” is a specific surface area that is measured according to the removal-processed toner 1008 illustrated in FIG. 4.

A difference between the above unprocessed toner 100A and the removal-processed toner 1008 is similar to that between the unprocessed toner 200A and the removal-processed toner 200B illustrated in FIGS. 2 and 5 respectively, and also similar to that between the unprocessed toner 300A and the removal-processed toner 300B illustrated in FIGS. 3 and 6 respectively.

In other words, the unprocessed toner 200A is the toner 200 before removal of the external additive 202, and the removal-processed toner 200B is the toner 200 after removal of the external additive 202. The unprocessed toner 300A is the toner 300 before removal of the external additive 302, and the removal-processed toner 300B is the toner 300 after removal of the external additive 302.

### [Removal Processing of External Additive]

Here is a procedure of the removal processing of the external additive 102, for example.

First, pure water is added into a non-ionic surfactant, and then that pure water is agitated while heating it to disperse the non-ionic surfactant within the pure water. This non-ionic surfactant is, for example, poly oxyethylene alkyl ether and the like. Conditions such as the heating time and the agitation time can be set arbitrarily. As a result, an aqueous surfactant solution can be obtained.

EMULGEN 5% aqueous solution manufactured by Kao Corporation may be used as the aqueous surfactant solution, for example.

Next, 100 ml (=100 cm³) of the aqueous surfactant solution is put into a beaker in which 3 g of the unprocessed toner 100A is stored, and then that aqueous surfactant solution is agitated (temperature=25° C.) (agitation time=40 minutes). Thereafter, the beaker is put into a water bath, and the water bath (temperature=38° C.) is vibrated using an ultrasonic vibrator (vibration time=40 minutes).

Next, the aqueous surfactant solution is sucked and filtered to collect residues. Thereafter, the residues are sufficiently washed and then the washed residues are dried off. Accordingly, the external additive 102 is purposely removed from the unprocessed toner 100A, and thus the removal-processed toner 1008, which is the dried residues, can be obtained.

Finally, in order to check whether the external additive 102 is sufficiently removed from the removal-processed toner 100B, a content rate of a specific element contained in the removal-processed toner 1008 is measured using one type or two or more types of element analyzers. For example, when silica is used as the external additive 102, this specific element is silicon (Si). In this case, an energy dispersive X-ray analyzer is used to measure the content rate of the silicon remained in the removal-processed toner 1008. EDX-800HS2 manufactured by SHIMADZU CORPORATION is used as the energy dispersive X-ray analyzer, for example. A condition for measuring the content rate of the silicon is X-ray voltage=15 kV under a helium gas atmosphere. When not more than 0.01% of the content rate of the specific element is obtained as a result of measuring the content rate of the specific element, it is determined that almost all of the external additive 102 is removed from the removal-processed toner 1008.

When the content rate of the specific element is more than 0.01%, the removal processing of the external additive 102 is not sufficient; thus, the above removal processing of the external additive 102 is repeated until the content rate of the specific element becomes not more than 0.01%.

### [Reason for Appropriate Range]

As described later, a reason for making the specific surface area difference ΔS within the above appropriate range is because the difference between the specific surface area S1 of the unprocessed toner 100A and the specific surface area S2 of the removal-processed toner 1008 is made appropriate, and thus the toner 100 is easily transferred onto the surface of the medium during image formation using the toner 100.

Hereinafter, details of the above reason are described with reference to the toner 100 according to the embodiment (FIGS. 1 and 4), the toner 200 of a first comparative example (FIGS. 2 and 5), and the toner 300 of a second comparative example (FIGS. 3 and 6).

As illustrated in FIG. 2, the toner 200 (the unprocessed toner 200A) includes, for example, a toner base particle 201 and an external additive 202. Structures of the toner base particle 201 and the external additive 202 are similar to that of the toner base particle 101 and the external additive 102 respectively. However, since there are multiple wrinkles W provided on a surface of the toner base particle 201, the whole unprocessed toner 200A is distorted according to the existence of the multiple wrinkles W. Thus, the circularity of the unprocessed toner 200A is smaller than the circularity of the unprocessed toner 100A.

As illustrated in FIG. 3, the toner 300 (the unprocessed toner 300A) includes, for example, a toner base particle 301 and an external additive 302. Structures of the toner base particle 301 and the external additive 302 are similar to that of the toner base particle 101 and the external additive 102 respectively. However, since there are multiple uneven parts U provided on the surface of the toner base particle 301, a three-dimensional shape of the unprocessed toner 300A is indeterminate according to the existence of the multiple uneven parts U. Thus, the circularity of the unprocessed toner 300A is smaller than the circularity of the unprocessed toner 200A and significantly smaller than the circularity of the unprocessed toner 100A.

In general, in a case of using the toner for forming an image, due to friction between the different toner and friction between the toner and the medium, the external additive falls out from the toner base particle. Thus, if the toner is used continuously, the specific surface area of that toner tends to be decreased.

Regarding the toner 200, once the removal processing of the external additive 202 is provided on the unprocessed toner 200A in order to purposely make the above general tendency about the specific surface area of the toner, the removal-processed toner 200B is obtained. In this case, since the specific surface area difference ΔS is out of the above appropriate range and, more specifically, since the specific surface area difference ΔS is too small, the difference between the specific surface area S1 of the unprocessed toner 200A and the specific surface area S2 of the removal-processed toner 200B is insufficient. Thus, even when the unprocessed toner 200A is used, the specific surface area S1 of that unprocessed toner 200A tends to be insufficiently decreased.

For example, focusing on a state of the toner base particle 201 onto which the external additive 202 is fused, it can be thought that since there are the multiple wrinkles W provided on the surface of the toner base particle 201 as described above, the toner base particle 201 is fundamentally distorted due to the existence of those multiple wrinkles W.

In this case, due to the existence of the multiple wrinkles W, the specific surface area S1 of the unprocessed toner 200A tends to be essentially large. Also, even when the external additive 202 falls out from the toner base particle 201 according to the usage of the unprocessed toner 200A, the specific surface area S2 of the removal-processed toner 200B tends to keep itself still large due to the existence of the multiple wrinkles W. Thus, since the difference between the specific surface area S1 of the unprocessed toner 200A and the specific surface area S2 of the removal-processed toner 200B is insufficient, even when the unprocessed toner 200A is used as described above, it is hard for the specific surface area S1 of the unprocessed toner 200A to be sufficiently decreased.

Accordingly, when the specific surface area difference ΔS is out of the appropriate range, a possibility that there are the multiple wrinkles W provided on the surface of the toner base practice 201 is increased. In this case, once the external additive 202 falls out from the toner base particle 201 according to the usage of the unprocessed toner 200A, due to the existence of the above multiple wrinkles W, the external additive 202 remained on the surface of the toner base particle 201 hardly exerts the external-addition function.

In specific, for example, as illustrated in FIG. 9, due to the existence of the multiple wrinkles W, in the unprocessed toner 200A, there is a valley V provided on the surface of the toner base particle 201. In this case, a part of the external additive 202 in the multiple particles form exists inside the valley V while the rest of the external additive 202 exists on the surface of the toner base particle 201. In this state, mainly, the external-addition function is easily exerted by the external additive 202 on the surface of the toner base particle 201.

However, when the unprocessed toner 200A is used, the external additive 202 on the surface of the toner base particle 201 easily falls out while the external additive 202 inside the valley V hardly falls out. Thus, for example, as illustrated in FIG. 10, in the removal-processed toner 200B, since an amount of the external additive 202 on the surface of the toner base particle 201, that is, an amount of the external additive 202 that can exert the external-addition function is insufficient, that external additive 202 hardly exerts the external-addition function.

Accordingly, due to the falling of the external additive 202 according to the usage of the toner 200, charge deficiency of the toner 200 easily occurs and the flow properties of the toner 200 are easily decreased. As a result, during image formation using the toner 200, that toner 200 is hardly transferred onto the surface of the medium.

A problem related to the above toner 200 (the unprocessed toner 200A and the removal-processed toner 200B) can be seen also in the toner 300 (the unprocessed toner 300A and the removal-processed toner 300B).

In other words, regarding the toner 300, once the removal processing of the external additive 302 is provided on the unprocessed toner 300A, the removal-processed toner 300B is obtained.

In this case, since there are the multiple uneven parts U provided on the surface of the toner base particle 301, due to the existence of the multiple uneven parts U, the specific surface area S1 of the unprocessed toner 300A tends to be essentially large. Also, even when the external additive 302 falls out from the toner base particle 301 according to the usage of the unprocessed toner 300A, the specific surface area S2 of the removal-processed toner 300B tends to keep it self still large due to the existence of the multiple uneven parts U. Thus, since the difference between the specific surface area S1 of the unprocessed toner 300A and the specific surface area S2 of the removal-processed toner 300B is insufficient, even when the unprocessed toner 300A is used as described above, it is hard for the specific surface area S1 of the unprocessed toner 300A to be sufficiently decreased.

Accordingly, when the specific surface area difference ΔS is out of the above appropriate range, a possibility that there are the multiple uneven parts U provided on the surface of the toner base practice 301 is increased. In this case, once the external additive 302 falls out from the toner base particle 301 according to the usage of the unprocessed toner 300A, due to the existence of the above multiple uneven parts U, the external additive 302 remained on the surface of the toner base particle 301 hardly exerts the external-addition function.

In specific, for example, as illustrated in FIGS. 9 and 10, due to the existence of the multiple uneven parts U, in the unprocessed toner 300A, there is a valley V provided on the surface of the toner base particle 301. In this case, in the removal-processed toner 300B, similar to the described case of the unprocessed toner 200A, since an amount of the external additive 302 on the surface of the toner base particle 301 is insufficient, that external additive 302 hardly exerts the external-addition function.

Accordingly, due to the falling of the external additive 302 according to the usage of the toner 300, charge deficiency of the toner 300 easily occurs and the flow properties of the toner 300 are easily decreased. As a result, during image formation using the toner 300, that toner 300 is hardly transferred onto the surface of the medium.

On the other hand, regarding the toner 100, once the removal processing of the external additive 102 is provided on the unprocessed toner 100A, the removal-processed toner 1008 is obtained. In this case, the specific surface area difference ΔS is within the above appropriate range, and that is, the specific surface area difference ΔS is sufficiently large. Thus, the difference between the specific surface area S1 of the unprocessed toner 100A and the specific surface area S2 of the removal-processed toner 1008 is sufficiently large. Accordingly, when the unprocessed toner 100A is used, the specific surface area S1 of the unprocessed toner 100A tends to be sufficiently decreased.

In this case, due to the existence of the external additive 102 fused on the toner base particle 101, the specific surface area S1 of the unprocessed toner 100A tends to be essentially large. On the other hand, once the external additive 102 falls out from the toner base particle 101 according to the usage of the unprocessed toner 100A, due to this falling of the external additive 102, the specific surface area S2 of the removal-processed toner 1008 tends to be essentially small. Thus, since the difference between the specific surface area S1 of the unprocessed toner 100A and the specific surface area S2 of the removal-processed toner 1008 is sufficiently large, when the unprocessed toner 100A is used, it is easy for the specific surface area S1 of the unprocessed toner 100A to be sufficiently decreased.

Accordingly, when the specific surface area difference ΔS is within the above appropriate range, the possibility that there are multiple wrinkles W and the multiple uneven parts U provided on the surface of the toner base particle 101 is low. In this case, even when the external additive 102 falls out from the toner base particle 101 according to the usage of the unprocessed toner 100A, the external additive 102 remained on the surface of the toner base particle 101 easily exerts the external-addition function.

In specific, for example, as illustrated in FIG. 7, in the unprocessed toner 100A, since no valley V is provided on the surface of the toner base particle 101, the external additive 102 in the multiple particles form exists on the surface of the toner base particle 101. In this case, even when a part of the external additive 102 on the surface of the toner base particle 101 falls out according to the usage of the unprocessed toner 100A, the rest of the external additive 102 still exists on the surface of the toner base particle 101. Thus, even when the unprocessed toner 100A is used, the amount of the external additive 102 for exerting the external-addition function is assured whereby the external additive 102 easily exerts the external-addition function.

Accordingly, even when the external additive 102 falls out according to the usage of the toner 100, charge deficiency of the toner 100 hardly occurs and the flow properties of that toner 100 are hardly decreased. As a result, during the image formation using the toner 100, that toner 100 is easily transferred onto the surface of the medium.

Especially, the specific surface area difference ΔS is preferably between 0.75 m²/g and 0.97 m²/g, because it allows the toner 100 to be sufficiently transferred onto the surface of the medium easily.

### [Reason for Focusing on Specific Surface Area S2 of Removal-Processed Toner]

As described above, in the embodiment, in order to improve transference properties of the toner 100 with respect to the surface of the medium, the specific surface area difference ΔS is defined. In this case, in order to define the specific surface area difference ΔS, a specific surface area S3 of the toner base particle 101 used in a step of manufacturing the toner 100 (the later-described toner base particle 101 before-external-addition processing) is not employed, but the specific surface area S2 of the removal-processed toner 1008 obtained by providing the removal processing of the external additive 102 on the unprocessed toner 100A is employed. Here is the reason for this.

As described above, when the toner 100 is used, since the external additive 102 falls out from the toner base particle 101, the amount of the external additive 102 existing on the surface of that toner base particle 101 is decreased. In addition, when the toner 100 is used continuously, whether the external additive 102 can continuously exert the external-addition function depends on the amount of the external additive 102 remained on the surface of the toner base particle 101, as described above. Thus, in order to stably transfer the toner 100 onto the surface of the medium by continuously exerting the external-addition function of the external additive 102 even when the toner 100 is used, it is required to focus on the state of the toner 100 when the remaining amount of the above external additive 102 is decreased due to the above falling of the external additive 102.

Here, the specific surface area S2 of the toner base particle 101 from which almost all external additive 102 falls out according to the usage of the toner 100 may be thought to be equal to the specific surface area S3 of the toner base particle 101 used in the step of manufacturing the above toner 100. With this idea, it can be thought that there is no need to obtain the specific surface area S2 by providing the removal processing of the external additive 102 on the unprocessed toner 100A if the above specific surface area S3 is already obtained.

However, in the case where the toner 100 is used continuously, while the external additive 102 falls out from the toner base particle 101, a state of the surface of the toner base particle 101 is changed due to an effect from that falling of the external additive 102, for example. Specifically, even when the surface of the toner base particle 101 is originally a substantially smooth curved surface, depending on, for example, how much the external additive 102 falls, there is a possibility that the surface of the toner base particle 101 gets rough. In addition, even when no valley V is originally formed on the surface of the toner base particle 101 (FIGS. 9 and 10), depending on, for example, how much the external additive 102 falls, there is a possibility that the valley V is not purposely formed on the surface of the toner base particle 101.

Accordingly, when the toner 100 is used continuously, the specific surface area S2 and the specific surface area S3 tend to be different from each other. Thus, it is required to factor the change of the state of the surface of the toner base particle 101 due to, for example, the above effect of the falling of the external additive 102 into the definition of the specific surface area difference ΔS. This is why in the embodiment, in order to define the specific surface area difference ΔS, the specific surface area S2 of the removal-processed toner 1008 is employed but not the specific surface area S3 of the toner base particle 101 used in the step of manufacturing the toner 100 is.

### <1-3. Manufacturing Method>

Next, a manufacturing method of the toner 100 is described.

The toner 100 is manufactured using the dissolution-suspension method according to the following procedure.

### [Preparation of Continuous Phase]

When the toner 100 is manufactured using the dissolution-suspension method, a continuous phase (what is called an aqueous phase) is prepared first.

Specifically, an inorganic dispersant (a suspension stabilizer) is added into an aqueous solvent, and then the aqueous solvent is agitated to dissolve or disperse that suspension stabilizer. In this case, an agitation device or the like may be used for agitating the aqueous solvent. Conditions such as the agitation speed and the agitation time can be set arbitrarily. Also, the aqueous solvent may be heated.

A type of the aqueous solvent is, for example, one type or two or more types of pure water; however, it is not limited thereto. A type of the suspension stabilizer is, for example, one type or two or more types of elements such as trisodium phosphate, calcium carbonate, calcium chloride, sodium hydrogen carbonate, potassium hydrogen carbonate, hydroxyapatite, calcium phosphate, and the like; however, it is not limited thereto. Especially, in a later-described granulation step, since the toner base particle 101 is granulated while the suspension stabilizer is fused on the surface thereof, that suspension stabilizer is preferably a material that is removable by using acid and the like, which has low affinity for the aqueous solvent.

### [Preparation of Dispersion Phase]

Next, the dispersion phase (what is called an oil phase) is prepared.

Specifically, a binder including polyester resin is added into an organic solvent, and then that organic solvent is agitated to dissolve or disperse that binder. In this case, an agitation device or the like may be used for agitating the organic solvent. Conditions such as the agitation speed and the agitation time can be set arbitrarily. Also, the organic solvent may be heated.

A type of the organic solvent is, for example, one type or two or more types of solvents such as a hydrocarbon solvent, an ester solvent, an ether solvent, a ketone solvent, and the like; however, it is not limited thereto. The hydrocarbon solvent is, for example, xylene, hexane, and the like. The ester solvent is, for example, methyl acetate, ethyl acetate, butyl acetate, isopropyl acetate, and the like. The ether solvent is, for example, diethyl ether and the like. The ketone solvent is, for example, acetone, methyl ethyl ketone, diisobutyl ketone, cyclohexanone, methyl cyclohexane, and the like.

Needless to say, one type or two or more types of other materials such as the colorant and the release agent described above may be added to the organic solvent with the binder.

### [Granulation]

Next, the toner base particle 101 is created by granulation using the above continuous phase and dispersion phase.

Specifically, first, the dispersion phase is mixed with the continuous phase, and then that mixture is agitated. This makes the mixture be suspended and granulated, thereby obtaining a slurry solvent including an agglomerated material. In this case, an agitation device or the like may be used for agitating the mixture. Conditions such as the agitation speed and the agitation time can be set arbitrarily. Also, the mixture may be heated.

Next, the slurry solvent is distilled under reduced pressure to volatilize and remove the organic solvent included within that slurry solvent. Thereafter, a pH adjuster is added into the slurry solvent, and then that slurry solvent is filtered to dissolve and remove the suspension stabilizer included within that slurry solvent. A type of the pH adjuster is, for example, acid such as nitric acid; however, it is not limited thereto.

Next, the agglomerated material is dewatered to collect that agglomerated material, and then the agglomerated material is dispersed again within aqueous solvent. Thereafter, the agglomerated material is washed using the aqueous solvent, and then the agglomerated material is filtered. Details of the aqueous solvent are what already described, for example.

Finally, the agglomerated material dewatered and dried off, and then that agglomerated material is classified. As a result, the toner base particle 101 can be obtained.

### [External-Addition Processing]

Finally, the external-addition processing is provided on the toner base particle 101. Specifically, the external additive 102 is mixed with the toner base particle 101, and then that mixture agitated. In this case, an agitation device or the like may be used for agitating the mixture. Conditions such as the agitation speed and time can be set arbitrarily. Also, the mix ratio of the toner base particle 101 and the external additive 102 can be set arbitrarily.

Accordingly, the external additive 102 is externally added on the toner base particle 101, and thus the external additive 102 is fused on the surface of the toner base particle 101. As a result, the toner 100 is completed.

### <1-4. Effect and Operation>

This toner 100 includes the binder that contains polyester resin, and the external additive 102. The difference ΔS obtained by subtracting the specific surface area S2 of the toner 100 after removal of the external additive 102 (the removal-processed toner 1008) from the specific surface area S1 of the toner 100 before removal of the external additive 102 (the unprocessed toner 100A) (=S1=S2) is 0.75 m²/g or more and less than 1.00 m²/g.

In this case, as described above, since the possibility that there are the multiple wrinkles W and the multiple uneven parts U provided on the surface of the toner base particle 101 is low, even when the external additive 102 falls out from the toner base particle 101 according to the usage of the toner 100, the external additive 102 easily exerts the external-addition function. Accordingly, the charge deficiency of the toner 100 hardly occurs and the flow properties of the toner 100 are hardly decreased.

As a result, during the image formation using the toner 100, the toner 100 is easily transferred onto the surface of the medium. This makes poor qualities of image such as fading and white lines hardly occur, and thus a high-quality image can be formed using the toner 100.

In particular, it is easy for the toner 100 to be sufficiently transferred onto the surface of the medium when the specific surface area difference ΔS is between 0.75 m²/g and 0.97 m²/g, and this allows much higher effect to be obtained.

In addition, when the circularity of the toner 100 before removal of the external additive 102 (the unprocessed toner 100A) is 0.950 or more, the possibility that there are the multiple wrinkles W and the multiple uneven parts U provided on the surface of the toner base particle 101 is significantly low. Thus, even when the toner 100 is used, it is easy for the external additive 102 to continuously exert the external-addition function, and this allows much higher effect to be obtained.

Moreover, according to the method of manufacturing the toner 100, using the dissolution-suspension method, the toner 100 in which the specific surface area difference ΔS is within the above appropriate range is manufactured by forming the toner base particle 101 including the binder that contains polyester resin, and then externally adding the external additive 102 onto that toner base particle 101. As a result, as described above, the poor qualities of image hardly occur during the image formation using the toner 100, and thus a high-quality image can be formed using that toner 100.

### <2. Image Formation Apparatus (Toner Cartridge and Development Device)>

Next, the image formation apparatus using the toner of one embodiment is described. Since a toner cartridge and a development device are a part of the image formation apparatus described herein, descriptions of the toner cartridge and the development device are also given below with that of the image formation apparatus.

The image formation apparatus described in this specification is apparatus that forms an image on a surface of a later-described medium M (see FIG. 11) using the toner, and that is what is called an electrophotographic full-color printer. The description of the structure of the toner is omitted because it is already described.

An image formation method of this image formation apparatus is, for example, an intermediate transfer method that forms an image using an intermediate transfer medium. In the image formation apparatus of that intermediate transfer type, in a step of forming an image, the toner is transferred onto the intermediate transfer medium, and then the toner is transferred onto the medium M from that intermediate transfer medium.

Material of the medium M is, for example, one type or two or more types of materials such as paper and a film; however, it is not limited thereto.

### <2-1. Overall Configuration>

First, an overall configuration of the image formation apparatus is described.

FIG. 11 is a plane view that illustrates a configuration of the image formation apparatus. In this image formation apparatus, during image formation, the medium M is transported along transportation routes R1 to R5. FIG. 11 illustrates the transportation routes R1 to R5 with broken lines.

Specifically, for example, as illustrated in FIG. 11, inside a housing 1, the image formation apparatus includes a tray 10, a feeding roller 20, a development device 30, a transfer device 40, a fixation device 50, the transportation rollers 61 to 68, and transportation route switch guides 69 and 70.

This image formation apparatus is, for example, capable of forming an image on only one side of the medium M and also capable of forming images on two sides of that medium M.

Hereinafter, in a case where the image formation apparatus forms an image on only one side of the medium M, the surface on which the image is formed is referred to as a “front surface” of the medium M. Meanwhile, the opposite surface of the front surface of the medium M is referred to as a “back surface.” In other words, in a case where the image formation apparatus forms images on both sides of the medium M, the images are formed on the front and back surfaces of the medium M respectively.

### [Housing]

The housing 1 includes, for example, one type or two or more types of materials such as metallic materials and polymer materials. The housing 1 is provided with a stacker 2 for delivering the medium M on which the image is formed. That medium M on which the image is formed is delivered to the stacker 2 through a delivery opening 1H provided in the housing 1.

### [Tray and Feeding Roller]

The tray 10, serving as a medium storage or a medium stacker, is detachably attached to the housing 1 and stores the medium M, for example. The feeding roller 20 is, for example, a cylindrical member extending in the Y-axis direction and rotatable about that Y-axis. As for a series of constituents described below, a constituent including a term “roller” in its name is a cylindrical member similar to the feeding roller 20, which is extending in the Y-axis direction and rotatable about that Y-axis.

The tray 10 stores the stacked multiple media M, for example. The multiple media M stored in the tray 10 are picked up from the tray 10 one by one by the feeding roller 20, for example.

The number of the tray 10 is not limited and it may be one or two or more. The number of the feeding roller 20 is not limited and it may be one or two or more. For example, FIG. 1 illustrates a case where the number of the tray 10 is one and the number of the feeding roller 20 is one.

### [Development Device]

The development device 30 is the development device of one embodiment. This development device 30 uses the toner and performs adherence processing (the development processing) of the toner with respect to a latent image (an electrostatic latent image). Specifically, mainly, the development device 30 forms the electrostatic latent image and makes the toner adheres onto the electrostatic latent image using the Coulomb force.

Here, the image formation apparatus includes, for example, five development devices 30 (30CL, 30Y, 30M, 30C, and 30K).

The development devices 30CL, 30Y, 30M, 30C, and 30K are, for example, detachably attached to the housing 1 and arranged along a moving route of a later-described intermediate transfer belt 41, for example. Here, the development devices 30CL, 30Y, 30M, 30C, and 30K are arranged in this order from the upstream side to the downstream side in a moving direction of the intermediate transfer belt 41 (an arrow F5).

The development devices 30CL, 30Y, 30M, 30C, and 30K have the same configurations but different types (colors) of toner stored in respective later-described toner cartridges 38 (see FIG. 12), for example.

Specifically, the clear toner is mounted in the development device 30CL. The yellow toner is mounted in the development device 30Y, for example. The magenta toner is mounted in the development device 30M, for example. The cyan toner is mounted in the development device 30C, for example. The black toner is mounted in the development device 30K, for example.

Configurations of the development devices 30CL, 30Y, 30M, 30C, and 30K are described later (see FIG. 12). Details of the clear toner, the yellow toner, the magenta toner, the cyan toner, and the black toner are just like above.

### [Transfer Device]

The transfer device 40 performs transfer processing using the toner on which the development processing is performed by the development device 30. Specifically, the transfer device 40 mainly transfers the toner adhered by the development device 30 on the electrostatic latent image to the medium M.

This transfer device 40 includes, for example, the intermediate transfer belt 41, a driven roller (idle roller) 42, a drive roller 43, a backup roller 44, a primary transfer roller 45, a secondary transfer roller 46, and a cleaning blade 47.

The intermediate transfer belt 41 is the above intermediate transfer medium. The intermediate transfer belt 41 is a medium onto which the toner is temporarily transferred before the toner is transferred on the medium M, and that is, for example, an endless elastic belt and the like. The intermediate transfer belt 41 includes, for example, one type or two or more types of polymer materials such as polyimide. This intermediate transfer belt 41 can move according to a rotation of the drive roller 43 while being extended between the driven roller 42, the drive roller 43, and the backup roller 44, for example.

The drive roller 43 is rotatable using a motor and the like, for example. Each of the driven roller 42 and the backup roller 44 is rotatable according to the rotation of the drive roller 43, for example.

The primary transfer roller 45 transfers (primarily transfers) the toner adhered on the electrostatic latent image to the intermediate transfer belt 41. This primary transfer roller 45 is pressed against the development device 30 (a later-described photoreceptor drum 32: see FIG. 12) while sandwiching the intermediate transfer belt 41.

The number of the primary transfer roller 45 is not limited and may be only one or two or more. Here, corresponding to the above five development devices 30 (30CL, 30Y, 30M, 30C, and 30K), the transfer device 40 includes five primary transfer rollers 45 (45CL, 45Y, 45M, 45C, and 45K). In addition, corresponding to one backup roller 44, the transfer device 40 includes one secondary transfer roller 46.

The secondary transfer roller 46 transfers (secondarily transfers) the toner transferred on the intermediate transfer belt 41 to the medium M. This secondary transfer roller 46 is pressed against the backup roller 44 and includes, for example, a metallic core material and an elastic layer such as a foamed rubber layer covering the outer surface of that core material.

The cleaning blade 47 is pressed against the intermediate transfer belt 41 and scrapes out an extraneous material such as needless toner remained on the surface of that intermediate transfer belt 41.

### [Fixation Device]

The fixation device 50 or a fusing device performs fixation processing (fusing processing) of the toner transferred on the medium M by the transfer device 40. Specifically, the fixation device 50 heats and pressurizes at the same time the toner transferred on the medium M by the transfer device 40 to fuse and fix the toner onto the medium M.

This fixation device 50 includes, for example, a heat roller 51 and a pressure roller 52.

The heat roller 51 heats the toner. This heat roller 51 includes, for example, a hollow cylindrical metallic core and a resin coat covering the surface of that metallic core. The metallic core includes, for example, one type or two or more types of metallic materials such as aluminum. The resin coat includes, for example, one type or two or more types of polymer materials such as a copolymer of tetrafluoroethylene and perfluoroalkyl vinyl ether (PFA), polytetrafluoroethylene (PTFE), and the like, for example.

For example, a heater such as a halogen heater and the like is provided inside the heat roller 51 (the metallic core). For example, a thermistor is arranged nearby the heat roller 51 while having a distance from the heat roller 51. For example, this thermistor measures the temperature of the surface of the heat roller 51.

The pressure roller 52 is pressed against the heat roller 51 and pressurizes the toner. This pressure roller 52 is, for example, a metallic rod. The metallic rod includes, for example, one type or two or more types of metallic materials such as aluminum.

### [Transportation Roller]

Each of the transportation rollers 61 to 68 includes each pair of rollers arranged so as to face to each other across the corresponding one of transportation routes R1 to R5 and transports the medium M picked up by the feeding roller 20

In a case where an image is formed on only one side (the front surface) of the medium M, that medium M is transported by the transportation rollers 61 to 64 along the transportation routes R1 and R2, for example. Meanwhile, in a case where images are formed on both sides (the front and back surfaces) of the medium, that the medium M is transported by the transportation rollers 61 to 68 along the transportation routes R1 to R5.

### [Transportation Route Switch Guide]

The transportation route switch guides 69 and 70 switch the transportation direction of the medium M depending on a condition such as a manner of the image formed on that medium M. The manner of image includes a manner that an image is formed on only one side of the medium M, and a manner that images are formed on both sides of the medium M.

### <2-2. Details of Configuration of Development Device>

Next, a configuration of the development device 30 is described.

FIG. 12 is a plane view that magnifies the configuration of the development device 30 (30CL, 30Y, 30M, 30C, and 30K) illustrated in FIG. 11.

As described later, the development devices 30CL, 30Y, 30M, 30C, and 30K have the same configurations but different types (the colors) of the toner stored in the respective toner cartridges 38, for example.

Specifically, for example, as illustrated in FIG. 12, each of the development devices 30CL, 30Y, 30M, 30C, and 30K includes the photoreceptor drum 32 serving as a latent image carrier member, a charge roller 33, a development roller 34 serving as a toner carrier member, a supply roller 35, a development blade 36, a cleaning blade 37, the toner cartridge 38, and a light source 39.

The photoreceptor drum 32, the charge roller 33, the development roller 34, the supply roller 35, the development blade 36, and the cleaning blade 37 are stored inside a housing 31, for example. The toner cartridge 38 is, for example, detachably attached to the housing 31. The light source 39 is, for example, arranged outside the housing 31.

Each of the development devices 30CL, 30Y, 30M, 30C, and 30K can move between a waiting position and a contacting position, for example. The waiting position is a position where the photoreceptor drum 32 is not pressed against the primary transfer roller 45 while sandwiching the intermediate transfer belt 41 since the photoreceptor drum 32 moves back to have a distance from the intermediate transfer belt 41. On the other hand, the contacting position is a position where the photoreceptor drum 32 is pressed against the primary transfer roller 45 while sandwiching the intermediate transfer belt 41 since the photoreceptor drum 32 moves forward to be close to the intermediate transfer belt 41.

### [Housing]

The housing 31 includes, for example, one type or two or more types of metallic materials, polymer materials, and the like. The housing 31 is, for example, provided with an opening 31K1 for partially exposing the photoreceptor drum 32 and an opening 31K2 for guiding light emitted from the light source 39 to the photoreceptor drum 32.

### [Photoreceptor Drum]

The photoreceptor drum 32 is a latent image carrier member of one embodiment, which mainly carries the electrostatic latent image formed thereon. Since the toner is adhered on the electrostatic latent image as described above, the photoreceptor drum 32 carries the electrostatic latent image onto which the toner is adhered. This photoreceptor drum 32 extends in the Y-axis direction and is rotatable about the Y-axis. The photoreceptor drum 32 is, for example, an organic photoreceptor including a cylindrical conductive support and a photoconductive layer covering the outer surface of that conductive support, and rotatable using a motor and the like. The conductive support is, for example, a metallic pipe including one type or two or more types of metallic materials such as aluminum. The photoconductive layer is, for example, a laminate including a charge generation layer, a charge transportation layer, and the like. A part of the photoreceptor drum 32 is exposed from the opening 31K1 provided in the housing 31.

### [Charge Roller]

The charge roller 33 mainly charges the surface of the photoreceptor drum 32. This charge roller 33 includes, for example, a metallic shaft and a semi-conductive epichlorohydrin rubber layer covering the outer surface of that metallic shaft. The charge roller 33 is pressed against the photoreceptor drum 32.

### [Development Roller]

The development roller 34 mainly carries the toner supplied from the supply roller 35 and adheres the toner onto the electrostatic latent image formed on the surface of the photoreceptor drum 32. This development roller 34 includes, for example, a metallic shaft and a semi-conductive urethane rubber layer covering the outer surface of that metallic shaft. The development roller 34 is pressed against the photoreceptor drum 32.

### [Supply Roller]

The supply roller 35 mainly supplies the toner onto the surface of the development roller 34. This supply roller 35 is what is called a sponge roller that includes, for example, a metallic shaft and a semi-conductive foamed silicone sponge layer covering the outer surface of that metallic shaft. The supply roller 35 is pressed against the development roller 34.

### [Development Blade]

The development blade 36 mainly regulates a thickness of the toner supplied on the surface of the development roller 34. This development blade 36 is, for example, arranged on a position having a predetermined distance from the development roller 34, and the thickness of the toner is controlled based on that distance (an interval) between the development roller 34 and the development blade 36. The development blade 36 includes, for example, one type or two or more types of metallic materials such as stainless.

### [Cleaning Blade]

The cleaning blade 37 is mainly a plate-form elastic member that scrapes out needless toner remained on the surface of the photoreceptor drum 32. This cleaning blade 37, for example, extends in a direction substantially parallel to the extending direction of the photoreceptor drum 32 and is pressed against that photoreceptor drum 32. The cleaning blade 37 includes, for example, one type or two or more types of polymer materials such as urethane rubber.

### [Toner Cartridge]

The toner cartridge 38 is the toner cartridge of one embodiment that mainly stores the toner. For example, here is the type (the color) of the toner stored in each toner cartridge 38. The toner cartridge 38 of the development device 30CL stores the clear toner, for example. The toner cartridge 38 of the development device 30Y stores the yellow toner, for example. The toner cartridge 38 of the development device 30M stores the magenta toner, for example. The toner cartridge 38 of the development device 30C stores the cyan toner, for example. The toner cartridge 38 of the development device 30K stores the black toner, for example. The image formation apparatus or the housing 1 thereof includes attachment parts to which toner cartridges 38 are detachably attached, respectively.

### [Light Source]

The light source 39 is mainly an exposure device, which exposes the surface of the photoreceptor drum 32 to form the electrostatic latent image on the surface of that photoreceptor drum 32. This light source 39 is, for example, a light-emitting diode (LED) head, which includes an LED element, a lens array, and the like. The LED element and the lens array are, for example, arranged so as to allow the light emitted from the LED element to form an image on the surface of the photoreceptor drum 32.

### <2-3. Performance>

Next, a performance of the image formation apparatus is described.

When forming an image on the surface of the medium M, for example, the image formation apparatus performs the development processing, primary transfer processing, secondary transfer processing, and fusing processing in this order, and also performs cleaning processing if required.

### [Development Processing]

First, the medium M stored in the tray 10 is picked up by the feeding roller 20. The medium M picked up by the feeding roller 20 is then transported along the transportation route R1 by the transportation rollers 61 and 62.

In the development processing, in the development device 30CL, once the photoreceptor drum 32 rotates, the charge roller 33 rotates to apply a direct-current voltage to the surface of the photoreceptor drum 32. This allows the surface of the photoreceptor drum 32 to be uniformly charged.

Then, based on the image data, the light source 39 irradiates the surface of the photoreceptor drum 32 with light. This allows a surface potential of a part of the surface of the photoreceptor drum 32 on which the irradiation with light is made to be attenuated (the light attenuation), and thus the electrostatic latent image is formed on the surface of that photoreceptor drum 32.

On the other hand, in the development device 30CL, the toner (the clear toner) stored in the toner cartridge 38 is ejected to the supply roller 35.

Once the supply roller 35 rotates, a voltage is applied to that supply roller 35. Thus, the clear toner is supplied on the supply roller 35.

Once the development roller 34 rotates while being pressed against the supply roller 35, a voltage is applied to that development roller 34. Thus, the clear toner supplied on the surface of the supply roller 35 is absorbed onto the surface of the development roller 34, and that clear toner is transported using the rotation of the development roller 34. In this case, a part of the clear toner adsorbed on the surface of the development roller 34 is removed by the development blade 36, and thus the thickness of the clear toner absorbed on the surface of that development roller 34 is made uniform.

After the photoreceptor drum 32 rotates while being pressed against the development roller 34, the clear toner absorbed on the surface of that development roller 34 transfers to the surface of the photoreceptor drum 32. This adheres the clear toner onto the surface (the electrostatic latent image) of the photoreceptor drum 32.

### [Primary Transfer Processing]

In the transfer device 40, once the drive roller 43 rotates, the driven roller 42 and the backup roller 44 rotate according to that rotation of the drive roller 43. Accordingly, the intermediate transfer belt 41 moves in an arrow F1 direction.

In the primary transfer processing, a voltage is applied to the primary transfer roller 45CL. Since this primary transfer roller 45CL is pressed against the photoreceptor drum 32 while sandwiching the intermediate transfer belt 41, the clear toner adhered on the surface (the electrostatic latent image) of the photoreceptor drum 32 is transferred onto the surface of the intermediate transfer belt 41 in the development processing.

Thereafter, the intermediate transfer belt 41 on which the clear toner is transferred moves in the arrow F1 direction continuously. Accordingly, in the development devices 30Y, 30M, 30C, and 30K and the primary transfer rollers 45Y, 45M, 45C, and 45K, the development processing and the primary transfer processing are performed through the same procedure that is performed in the above development device 30CL and the primary transfer roller 45CL. Thus, each of the yellow toner, the magenta toner, the cyan toner, and the black toner is transferred onto the surface of the intermediate transfer belt 41.

Specifically, the development device 30Y and the primary transfer roller 45Y transfer the yellow toner onto the surface of the intermediate transfer belt 41. The development device 30M and the primary transfer roller 45M transfer the magenta toner onto the surface of the intermediate transfer belt 41. The development device 30C and the primary transfer roller 45C transfer the cyan toner onto the surface of the intermediate transfer belt 41. The development device 30K and the primary transfer roller 45K transfer the black toner onto the surface of the intermediate transfer belt 41.

Needless to say, whether the development processing and the primary transfer processing are actually performed by the development devices 30CL, 30Y, 30M, 30C, and 30K and the primary transfer rollers 45CL, 45Y, 45M, 45C, and 45K is determined depending on a color (color combination) required for forming the image.

### [Secondary Transfer Processing]

The medium M transported along the transportation route R1 passes between the backup roller 44 and the secondary transfer roller 46.

In the secondary transfer processing, a voltage is applied to the secondary transfer roller 46. Since this secondary transfer roller 46 is pressed against the backup roller 44 while sandwiching the medium M, the toner transferred on the intermediate transfer belt 41 in the above primary transfer processing is transferred onto the medium M.

### [Fusing Processing]

After the toner is transferred on the medium M in the secondary transfer processing, the medium M is transported along the transportation route R1 continuously and is brought into the fixation device 50.

In the fusing processing, temperature of the surface of the heat roller 51 is controlled to be a predetermined temperature. Once the pressure roller 52 rotates while being pressed against the heat roller 51, the medium M is transported so as to pass between that heat roller 51 and the pressure roller 52.

Since the toner transferred on the surface of the medium M is accordingly heated, that toner melts. In addition, because the melted toner is pressed against the medium M, that toner is tightly adhered on the medium M.

The toner is accordingly fused on the medium M, and thus an image is formed on the surface of that medium M. The medium M on which the image is formed is transported along the transportation route R1 and then delivered to the stacker 2 through the delivery opening 1H.

### [Cleaning Processing]

In the development device 30, there may be a case where the needless toner is remained on the surface of the photoreceptor drum 32. This needless toner is, for example, a part of the toner used in the primary transfer processing, which is the toner not transferred onto the intermediate transfer belt 41 and remained on the surface of the photoreceptor drum 32.

In the development device 30, the photoreceptor drum 32 thus rotates while being pressed against the cleaning blade 37 to scrape out the toner remained on the surface of that photoreceptor drum 32 by the cleaning blade 37. As a result, the needless toner is removed from the surface of the photoreceptor drum 32.

### <2-4. Operation and Effect>

According to these of the toner cartridge 38, the development device 30, and the image formation apparatus, since the development processing is performed using the toner of an embodiment, that toner is easily transferred onto the surface of the medium M during the image formation using the toner as described above. As a result, poor qualities of image such as fading and white lines hardly occur, and thus a high-quality image can be formed using the toner. Other operations and effects are just like the above.

### <3. Modification>

The above-described configuration, operation, and the like of the image formation apparatus can be changed properly.

Specifically, out of the five types of toner (the clear toner, the yellow toner, the magenta toner, the cyan toner, and the black toner) used in the above image formation apparatus, all types of the toner may have the same structures as the toner according to an embodiment, or a part of the toner may have the same structure as the toner according to an embodiment. This “a part of the toner” may be one type of toner, two types of toner, three types of toner, or four types of toner out of the above five types of toner.

### EXAMPLES

Examples are described in detail. Here is the order of the descriptions.

1. Toner Manufacturing

2. Image Evaluation

### <1. Toner Manufacturing>

First, according to the following procedure, the clear toner is manufactured using the dissolution-suspension method.

### Examples 1 to 9

First, the continuous phase is prepared. In this case, firstly, 11024 pts. wt. of a suspension stabilizer (trisodium phosphate) is mixed with 329678 pts. wt. of aqueous solvent (pure water), and that mixture is then agitated (temperature=60° C.) to obtain a first water solution. Next, 5319 pts. wt. of a suspension stabilizer (calcium chloride) is mixed with 43234 pts. wt. of aqueous solvent (pure water), and that mixture is then agitated to obtain a second water solution. Then, the first and second water solutions are mixed, and the mixture (temperature=60° C.) is agitated using an agitation device (a disperser neo mixer manufactured by PRIMIX Corporation) (rotational speed=4300 rpm, agitation time=50 minutes).

Next, the dispersion phase is prepared. In this case, firstly, an organic solvent is prepared (ethyl acetate, temperature=50° C.). Thereafter, 1552 pts. wt. of a release agent (paraffin wax) and 40.35 pts. wt. of a fluorescent whitening agent are mixed with the organic agent in this order, and then that mixture agitated. Thereafter, 19091 pts. wt. of a binder (crystalline polyester resin) is mixed with the mixture, and then that mixture is agitated.

Next, the toner base particle is created by granulation using the continuous phase and the dispersion phase. In this case, the dispersion phase is mixed with the continuous phase, and then the mixture (temperature=55° C.) is agitated using the above agitation device (rotational speed=1700 rpm, agitation time=50 minutes). This allows the mixture to be suspended and granulated, and thus the slurry solvent including the agglomerated material is obtained. Next, the slurry solvent is distilled under reduced pressure to volatilize and remove the organic solvent (ethyl acetate) included within that slurry solvent. Thereafter, a pH adjuster (nitric acid) is added into the slurry solvent, and then the slurry solvent is filtered to dissolve and remove the suspension stabilizer. Next, the agglomerated material included in the slurry solvent is dewatered, and then the agglomerated material is dispersed again within aqueous solvent (pure water). Thereafter, the agglomerated material is washed using the aqueous solvent (pure water), and then the agglomerated material is filtered. After that, the agglomerated material is dewatered and dried off, and then that agglomerated material is classified.

Finally, the clear toner is created by providing the external-addition processing on the toner base particle. In this case, 5 pts. wt. of the external additive is mixed with 100 pts. wt. of the toner base particle, and then the mixture is agitated using an agitation device (Henschel Mixer manufactured by NIPPON COKE & ENGINEERING CO., LTD.) (rotational speed=5400 rpm, agitation time=10 minutes). A mixture of 2.5 pts. wt. of silica having a small particle size (hydrophobic fumed silica RY50 manufactured by NIPPON AEROSIL CO., LTD.) and 2.5 pts. wt. of colloidal silica (sol-gel spherical-silica fine particles X24-9163A manufactured by Shin-Etsu Chemical Co., Ltd.) is used as the external additive. An average particle size of the external additive (median size D50) is about 7 μm to 8 μm.

As a result, the external additive is fused on the surface of the toner base particle, and thus the clear toner is completed.

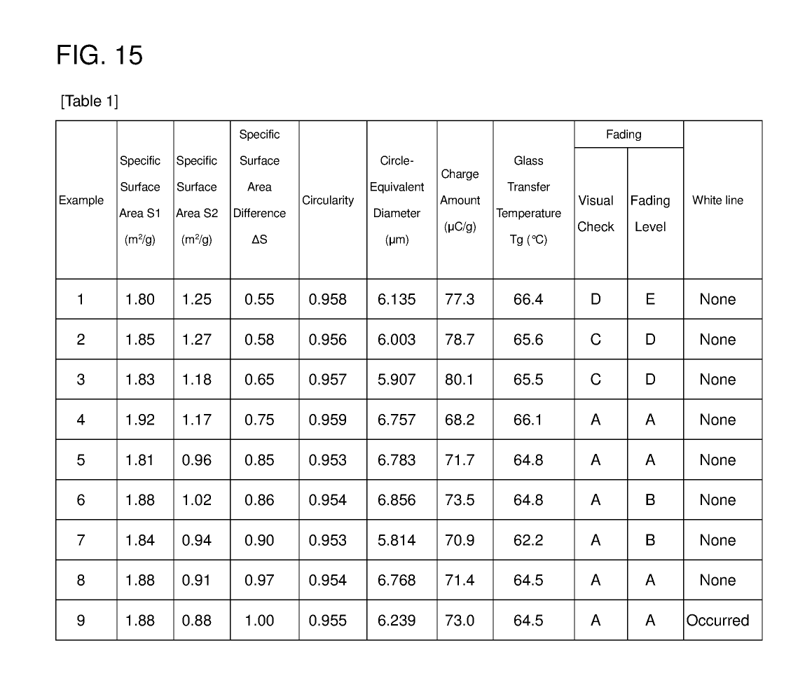

The physical properties of this clear toner of Examples 1 to 9 are indicated in Table 1 (FIG. 15). As the physical properties of the toner, Table 1 (FIG. 15) indicates the specific surface area S1 of the unprocessed toner (m²/g), the specific surface area S2 of the removal-processed toner (m²/g), the specific surface area difference ΔS (m²/g), the circularity, a circle-equivalent diameter (μm), a charge amount (μC/g), and a glass transfer temperature Tg (° C.).

When manufacturing the clear toner, manufacturing conditions such as distillation temperature and pressure reducing speed during distilling the slurry solvent under reduced pressure are adjusted. The specific surface areas S1 and S2 are accordingly changed, and thus the specific surface area difference ΔS is changed.

The procedures for measuring the specific surface areas S1 and S2 and for calculating the specific surface area difference ΔS are just like above. The procedure for obtaining the removal-processed toner using the unprocessed toner, that is, the procedure of the removal processing of the external additive is just like above.

In order to measure the circularity and calculate the circle-equivalent diameter (μm), a flow particle image analyzer (a rapid particle size and shape analyzer FPIA-3000S manufactured by SYSMEX CORPORATION) is used to analyze the clear toner.

In order to measure the charge amount, the clear toner is mixed with the carrier, and then that mixture is shaken (shake time=120 seconds) to measure the charge amount of that clear toner. A charge amount measurement device TB-203 manufactured by KYOCERA Chemical Corporation is used as a measurement device of the charge amount, and N-01 manufactured by the Imaging Society of Japan is used as the carrier. Environment conditions are temperature=25° C. and humidity=50%.

In order to measure the glass transfer temperature Tg, a heat analyzer (Differential Scanning calorimeter DSC-6220 manufactured by Seiko Instruments Inc.) is used to analyze the clear toner. In this case, the temperature range is between 20° C. and 180° C., and a temperature increase rate is 1° C./min.

### <2. Image Evaluation>

Next, the image formation apparatus in which the above clear toner is mounted is used to form an image on the surface of the medium, and then the results indicated in Table 1 (FIG. 15) are obtained by evaluating the quality of that image.

### [Procedure of Image Formation]

Here is the procedure for forming an image.

FIG. 13 is a plane view that illustrates a configuration of the medium M on which a later-described image G3 for density measurement is formed. An arrow in the upward direction illustrated in FIG. 13 indicates a moving direction D of the medium M during the image formation. In FIG. 13, a region in which the image G3 is formed is shaded.

There are three environment conditions in the image formation. Specifically, the conditions are a normothermic condition (temperature=23±1° C., humidity=50 ±5%), a cold condition (temperature=10±1° C., humidity=20±5%), and a hot condition (temperature=27±1° C., humidity=80±5%).

In order to form an image, the image formation apparatus illustrated in FIGS. 11 and 12 is used. Specifically, a Color LED Printer C711dn manufactured by Oki Data Corporation is used.

In this case, the photoreceptor drum (outside diameter=about 40 mm), the urethane-made development roller (outside diameter=about 22 mm, degree of Asker C hardness=80±5, peripheral speed=113 mm/min to 138 mm/min), and the supply roller (outside diameter=about 14 mm) are used. This “peripheral speed” is linear speed in the tangent direction with respect to the outer periphery of the development roller. The conditions of voltage application are a voltage applied to the development roller=−130V, a voltage applied to the supply roller=−210V, and a voltage applied to the charge roller is −1000V.

High-quality paper color copy (weighting=160 g/cm³, A4 size) manufactured by Fuji Xerox Co., Ltd. is used as the medium M. The moving direction D of the medium M during the image formation is the direction of the shorter sides of the medium M as illustrated in FIG. 13. This “direction of the shorter sides” is a direction along the extending direction of the two shorter sides included in the two longer sides and two shorter sides that the medium M (A4 size) has.

Three types of images (an image G1, an image G2, and the image G3) are used as the image formed on the surface of the medium. The image G1 is an image for continuous photographic printing, and a pattern of that image G1 is a fine line pattern (printing rate=5%). The image G2 is an image for image evaluation, and a pattern of that image G2 is a half tone pattern (printing rate=25%). The image G3 is an image for the density measurement, and a pattern of that image G3 is a solid pattern (printing rate=100%).

A continuous photographic printing test is performed when forming an image. In this continuous photographic printing test, the image G1 is formed on each surface of 3000 pieces of the media, and then a step of forming the image G2 on the surface of one piece of the medium and forming the image G3 on the surface of one piece of the medium is repeated for multiple times. In this case, the continuous photographic printing test is performed until the number of the formed image G1 (the total number of the medium on which the image G1 is formed) reaches 21000.

### [Procedure of Image Evaluation]

Here is a procedure for evaluating the image formed under the above three environment conditions. In this case, in order to evaluate the quality of the image, occurrence statuses of fading and white lines are checked.

### (Procedure of Evaluation Related to Fading Occurrence Status)

The “fading” is, in other words, color unevenness of an image. It is thought that the color unevenness occurs because of a trouble in transferring the clear toner onto the medium and, more specifically, because an amount of the transfer of the clear toner onto the medium is varied. In other words, whereas the color unevenness hardly occurs in the image when transfer properties of the clear toner with respect to the medium is assured, the color unevenness easily occurs in the image when the transfer properties of the clear toner with respect to the medium is insufficient.

In order to check the fading occurrence status, the last medium on which the image G2 is formed is used to visually check the state of that image G2 and the fading occurrence status is determined from a viewpoint of the visual check. In this case, a case where almost no fading occurs is “A,” a case where fading occurs is “C,” and a case where fading significantly occurs is “D.”

The image G2 having the half tone pattern (printing rate=25%) is used for visually checking the fading occurrence status because the fading is likely to occur under the condition of a low printing rate. In other words, the fading occurrence status is strictly evaluated by checking that fading occurrence status based on the image G2 on which the fading easily occurs essentially, or the image G2 having low density.

In addition, when checking the fading occurrence status, later-described fading levels A to E are determined by following a procedure below to determine the fading occurrence status from a viewpoint of density.

First, the last medium on which the image G3 is formed is used to measure the density of that image G3. In this case, as illustrated in FIG. 13, the density of each of three positions (positions P1, P2, and P3), which are spaced from each other and are in a position having a distance L1 (=30 mm) from a front end T1 of the image G3 in the moving direction D of the medium M, is measured to calculate an average value of the density of these three positions (front end average density). In addition, the density of each of three positions (positions P4, P5, and P6), which are spaced from each other and are in a position having a distance L2 (=30 mm) from a back end T2 of the image G3 in the moving direction D of the medium M, is measured to calculate an average value of the density of these three positions (back end average density). A densitometer X-Rite 528 manufactured by X-Rite, Inc. is used as a measurement device of the density.

Next, based on the above image G3 as well as the front end average density and the back end average density, the fading occurrence status is temporarily evaluated. In this case, whether density variation (what is called color unevenness) occurs in the image G3 is determined by visual check, and when the density variation occurs, a rate of the region where the density variation occurs (a density variation occurrence rate) is obtained to determine a temporary fading level out of 10 stages (=1 to 10). This “density variation occurrence rate” is a rate of an area SB of the density variation occurrence region to an area SA of the whole region of the image G3, and that is calculated from the following: density variation occurrence rate (%)=(SB/SA)×100.

Here are criterion for determining the temporary fading level.

(1) Temporary Fading Level 10

A case where the density variation occurrence rate is 0% since no density variation occurs.

(2) Temporary Fading Level 9

A case where the density variation occurs and the density variation occurrence rate is less than 5%.

(3) Temporary Fading Level 7

A case where the density variation occurs and the density variation occurrence rate is between 5% or more and less than 15%.

(4) Temporary Fading Level 5

A case where the density variation occurs and the density variation occurrence rate is between 15% or more and less than 30%.

However, when the density variation occurs, the above temporary fading levels are corrected. Specifically, −1 is added to each temporary fading level when the density variation is 0.4 or less, and −2 is added to each temporary fading level when the density variation is more than 0.4. This “density variation” is a difference between the highest density and the lowest density.

As a result, when the temporary fading level is 6 or more, it is determined that the fading occurrence status is good; on the other hand, when the temporary fading level is 5 or less, it is determined that the fading occurrence status is bad.

Next, when the temporary fading level is 5 or less, the voltage applied to the development roller is changed from −130V to −150V, and then the above continuous photographic printing test is performed again to determine the temporary fading level once again. In addition, when the temporary fading level still remains 5 or less, the voltage applied to the development roller is changed from −150V to −170V, and then the above continuous photographic printing test is performed again to determine the temporary fading level once again.

Finally, based on the above temporary fading level, the final evaluation of the fading occurrence status is performed. In this case, 5 stages of fading levels (=A to E) are determined using the temporary fading level as the presumption and concerning whether there is the above change of the voltage applied to the development roller.

Here are criterion for determining the fading level.

(1) Fading Level A

When the temporary fading level is 6 or more, that is, when there is no change of the applied voltage in any of the three environment conditions.

(2) Fading Level B

When the applied voltage is changed to −150V in either of the three environment conditions, and the number of changing the applied voltage under the same environment condition is 2 or less.

(3) Fading Level C

When the applied voltage is changed to −150V in either of the three environment conditions, and the number of changing the applied voltage under the same environment condition is 3 or more.

(4) Fading Level D

When the applied voltage is changed to −170V in either of the three environment conditions, and the number of changing the applied voltage under the same environment condition is 2 or less.

(5) Fading Level E

When the applied voltage is changed to −170V in either of the three environment conditions, and the number of changing the applied voltage under the same environment condition is 3 or more.

As a result, when the fading level is A or B, almost no fading occurs, and thus it is determined that the fading occurrence status is good. On the other hand, when the fading level is C, D, or E, the fading occurs, and thus it is determined that the fading occurrence status is bad.

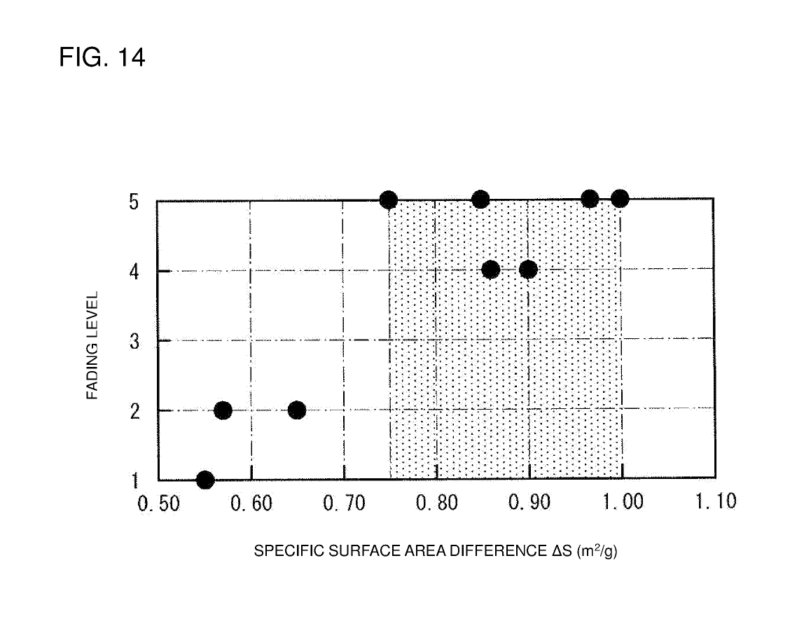

FIG. 14 illustrates a correlation between the specific surface area difference ΔS (m²/g) and the fading levels. In FIG. 14, a region of the specific surface area difference ΔS in which the fading occurrence status is good is shaded.

### (Procedure of Evaluation Related to White Lines Occurrence Status)

The “white lines” are the poor quality of image such as streaks occurring in that image. It is thought that the white lines occur because of a trouble in transferring the clear toner onto the medium and, more specifically, because the clear toner is not transferred onto a specific region of the medium. In other words, whereas the white lines hardly occur in the image when the clear toner is normally transferred onto the medium, the white lines easily occur in the image when the clear toner is not normally transferred onto the medium.

In order to check the white lines occurrence status, the last medium on which the image G1 is formed is used to visually check whether any white streak occurs within that image G1.

FIG. 15 is Table 1 illustrating the physical properties of the clear toner of Examples 1 to 9.

### [Consideration]

As indicated in Table 1 shown in FIG. 15, the high circularity that is about 0.950 or more is obtained using the clear toner manufactured using the dissolution-suspension method.

When that clear toner having such a high circularity, the fading occurrence status seldom depends on the circularity, the circle-equivalent diameter, and the glass transfer temperature Tg. However, the fading occurrence status changes a lot depending on the specific surface area difference ΔS.

Specifically, when the specific surface area difference ΔS is within a specific range (=0.75 m²/g to 1.00 m²/g) (Examples 4 to 9), the fading hardly occurs comparing with the case where the specific surface area difference ΔS is out of the above specific range (Examples 1 to 3). The charge amount when the specific surface area difference ΔS is within the above specific range is between 68.2 μC/g and 73.5 μC/g.

However, the white lines occur when the specific surface area difference ΔS is 1.00 (Example 9), and this is a difference from the case where the specific surface area difference ΔS is less than 1.00 (Example 4 to 8). It is thought that the white lines occur because of filming of the development blade.

Thus, as indicated in Table 1 (FIG. 15) and FIG. 14, when the specific surface area difference ΔS is 0.75 m²/g or more and less than 1.00 m²/g, the fading hardly occurs and also the white lines hardly occur. In this case, particularly when the specific surface area difference ΔS is between 0.75 m²/g and 0.97 m²/g, both fading and white lines hardly occur sufficiently.

Accordingly, when the specific surface area difference ΔS is 0.75 m²/g or more and less than 1.00 m²/g, the poor qualities of image (the fading and the white lines) hardly occur, and thus a high-quality image can be formed.

Although the invention is described with reference to the embodiments, the present invention is not limited to the aspects described in the above embodiments, and various modifications are available.

Specifically, for example, the image formation apparatus of one embodiment is not limited to a printer, and may be a copier, a facsimile, a multifunction printer, and the like.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

1. A toner comprising:
a toner base particle that includes a binder that contains polyester resin; and
an external additive externally added to the toner base particle, wherein
a difference obtained by subtracting a specific surface area of the toner after removal of the external additive from a specific surface area of the toner before removal of the external additive is 0.75 m²/g or more and less than 1.00 m²/g.

2. The toner according to claim 1, wherein
the difference is 0.75 m²/g or more and 0.97 m²/g or less.

3. The toner according to claim 1, wherein
a circularity of the toner before removal of the external additive is 0.950 or more.

4. The toner according to claim 1, wherein
the toner base particle formed by a dissolution-suspension method comprising:
adding the polyester resin into an organic solvent to obtain a dispersion phase; mixing the dispersion phase with a continuous phase containing water; and agitating the mixture to make the mixture be granulated.

5. The toner according to claim 1, wherein
the removal of the external additive from the toner comprising: mixing the toner before removal of the external additive with an aqueous surfactant solution including a surfactant and a pure water; and vibrating the mixture using an ultrasonic vibrator.

6. The toner according to claim 1, wherein
a content rate of silicon in the toner after removal of the external additive is more than 0.01%,

7. The toner according to claim 6, wherein
the content rate is measured by an energy dispersive X-ray analyzation.

8. The toner according to claim 1, wherein
the specific surface area is measured by a BET method using nitrogen.

9. A toner cartridge that stores therein the toner according to claim 1.

10. A development device comprising:
the toner according to claim 1; and
a toner carrier member on which the toner is carried; and
a latent image carrier member that carries a latent image to which the toner from the toner carrier member is to be adhered to form a toner image.

11. An image formation apparatus comprising:
a medium storage in which a medium is placed;
the development device according to claim 10;
a transfer device that transfers the toner image from the development device to the medium conveyed from the medium storage; and
a fixation device that fuses the toner image transferred on the medium to the medium.
